(19) United States
(12) Patent Application Publication
(10) Pub. No.: US 2008/0244417 A1
(43) Pub. Date: Oct. 2, 2008

(54) PRESENCE-ENHANCED CALENDARING

(76) Inventors: Nigel D. Simpson, Bainbridge Island, WA (US); Nicole Y. Mordecai, Weston, MA (US)

Correspondence Address: BARRY W. CHAPIN, ESQ.;CHAPIN INTELLECTUAL PROPERTY LAW, LLC, WESTBOROUGH OFFICE PARK, 1700 WEST PARK DRIVE, SUITE 280, WESTBOROUGH, MA, 01581, US

(21) Appl. No.: 11/694,092

(22) Filed: Mar. 30, 2007

(51) Int. Cl. G06F 3/00

(52) U.S. Cl. 715/751

(57) ABSTRACT

Presence-enhanced calendaring is provided. A user can enter scheduled-activity information related to the user in a manner consistent with conventional calendaring systems. In addition to receiving scheduled-activity information related to a user, the presence-enhanced calendaring systems receive sensor-generated information related to a current activity of the user. The presence-enhanced calendaring system integrates the sensor-generated information related to a current activity of the user with the scheduled-activity information related to the user.

### FIELD OF THE INVENTION

The present disclosure relates generally to calendaring systems. In particular embodiments described herein, sensor-generated information related to a user's current activity can be incorporated into the calendaring system's activity information related to the user.

### BACKGROUND OF THE INVENTION

The typical modern workplace is heavily computerized, with communication, scheduling, and work output all now either primarily or entirely computer based. Groups of people who need to work together regularly use electronic calendars capable of being shared across a network to coordinate their activities. These electronic calendars are sometimes referred to as groupware calendaring systems (“GCSs”).

Group members publish their schedules, allowing group members to determine good times to schedule future appointments and good times to contact other group members. Publishing and sharing schedule information in this manner can be particularly important for distributed teams that can not meet face to face and often have the added complexity of dealing with multiple time zones.

### SUMMARY OF THE INVENTION

Conventional electronic calendar systems frequently do not accurately reflect what a user of a system is actually doing at a given time. For example, a scheduled meeting may often run late or get canceled without having the meeting time changed or deleted in all of the calendars for the meeting's participants. In the situation when a meeting runs late and the participants' calendars are not updated, the participants' calendars may indicate that the participants are available immediately after the original scheduled time for the meeting to end when, in fact, the participants are still in the meeting and unavailable. In the situation when a meeting is canceled and the participants' calendars are not updated, the participants' calendars indicate that the participants are in a meeting and unavailable for a phone conversation, for example, when, in fact, the participants may actually be in their office and available for a phone conversation.

Additionally, people frequently use a calendaring system to remind them of meetings and other “TODOs” and don't always enter into their calendar other meetings and “TODOs” that occur regularly enough so as not to require a reminder. For example, people generally don't include in their calendar the time they go to lunch, which may vary from day to day. Thus, while a person is at lunch their calendar may actually reflect that they are available.

Thus, conventional calendaring systems can act as a guide to an individual's availability, but conventional calendaring systems frequently cannot be relied on for specific availability at a given point in time. Inventive matter discussed herein deviates with respect to and improves upon conventional calendaring systems and other technology also known in the prior art. Embodiments described herein allow a calendaring system to reflect a user's current activity (i.e., presence) in the user's calendar. In particular embodiments, an existing conventional calendaring system may be modified in accordance with the inventive matter disclosed herein. In other particular embodiments, an entirely new calendaring system may be created in accordance with the inventive matter disclosed herein.

A first embodiment provides logic encoded in one or more tangible media for execution and, when executed, operable to receive, into a calendaring system, sensor-generated information related to a current activity of a user of the calendaring system. The logic is also operable to integrate, in the calendaring system, the received sensor-generated information with scheduled-activity information related to the user. Logic disclosed herein may be created as a separate module that can be added to an existing calendaring system. Also, logic disclosed herein may be created as in integral part of a newly created calendaring system.

In a second embodiment, methods for enhancing scheduled-activity information related to a user of a calendaring system are provided. In particular embodiments, a calendaring system receives sensor-generated information related to a current activity of a user of the calendaring system. The calendaring system integrates the received sensor-generated information related to the user with scheduled-activity information related to the user.

In a third embodiment, a calendaring system is provided. Calendaring systems disclosed herein comprise a user interface adapted to receive scheduled-activity information related to a user; a sensor adapted to generate information related to a current activity of the user; a sensor module adapted to receive sensor-generated information related to the user; a control module adapted to integrate received scheduled-activity information related to the user and received sensor-generated information related to the user; and a calendar module adapted to maintain the integrated information. In operation of a calendaring system, a user may interact with the user interface to enter, modify, or delete scheduled-activity information related to the user. The calendar module maintains the received scheduled-activity information related to the user. The sensors generate information related to a current activity of users. The sensor module operates as an interface between the sensors and the control module. The control module is adapted to integrate received sensor-generated information related to a user with scheduled-activity information related to the user. In particular embodiments, the calendar module will maintain received scheduled-activity information, received sensor-generated information, and the information integrated by the control module.

It is to be understood that the inventive matter disclosed herein may be embodied strictly as a software program, as software and hardware, or as hardware alone. The features disclosed herein may be employed in workstations and other computerized devices and software systems for such devices such as those manufactured by Sun Microsystems, Inc., of Santa Clara, Calif.

### BRIEF DESCRIPTION OF THE DRAWINGS

The above and further objects, features, and advantages of disclosed embodiments may be better understood by referring to the following description of example embodiments in conjunction with the accompanying drawings, in which like reference characters indicate like structural elements and features in the various figures. The drawings are not meant to limit the scope of the invention. For clarity, not every element may be labeled in every figure. The drawings are not necessarily to scale, emphasis instead being placed upon illustrating embodiments, principles, and concepts.

FIG. 1 illustrates a calendaring system in accordance with embodiments disclosed herein.

FIG. 2 is a block diagram of a computer environment illustrating an example architecture of a respective computer system useful in implementing a calendaring system according to embodiments disclosed herein.

FIG. 3 illustrates procedures performable by a calendaring system in accordance with embodiments disclosed herein.

FIG. 4 illustrates additional procedures performable by a calendaring system in accordance with embodiments disclosed herein.

FIG. 5 illustrates additional procedures performable by a calendaring system in accordance with embodiments disclosed herein.

FIG. 6 illustrates additional procedures performable by a calendaring system in accordance with embodiments disclosed herein.

### DESCRIPTION OF EXAMPLE EMBODIMENTS

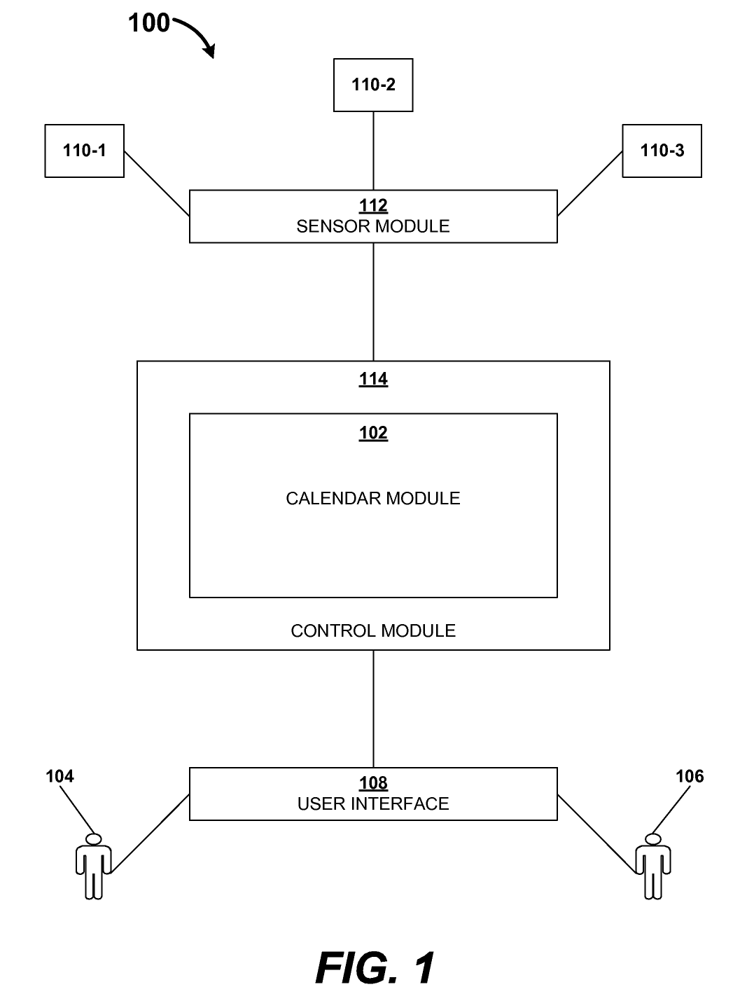

FIG. 1 illustrates a calendaring system 100 in accordance with embodiments disclosed herein. The calendaring system 100 includes a calendar module 102, a user interface 108, three sensors 110-1, 110-2, 110-3 (generally 110), a sensor module 112, and a control module 114.

In operation, a user 104 interacts with the user interface 108 to enter, delete, modify scheduled-activity information related to the user 104. The type of scheduled-activity information that the user 104 enters may be the same as in conventional calendaring systems. Typically, the user 104 will enter information reflecting scheduled or otherwise intended activities of the user 104. For example, if the user 104 schedules a meeting with a group of people, the user 104 may enter the day, time, and location of the meeting. The user 104 may enter other information as well, such as a list of attendees and a brief description of the purpose of the meeting. The user 104 may also enter information describing other scheduled activities, such as a reminder to place a telephone call to an individual at a particular time or a reminder to perform or finish a particular task in a given time period.

The calendar module 102 maintains the entered scheduled-activity information related to the user 104. While the calendar module 102 maintains the user's 104 scheduled-activity information, the user 104 may interact with the user interface 108 to modify or delete the scheduled-activity information. For example, if the time or place of a scheduled meeting is changed, the user 104 may interact with the user interface 108 to amend the scheduled meeting. Similarly, if a scheduled meeting is canceled, the user 104 may interact with the user interface 108 to delete the information pertaining to the previously scheduled meeting.

The sensors 110 generate information related to a current activity of the user 104. A sensor 110 can be a hardware device, a software application, or a device having both hardware and software components. This sensor-generated information may be view as detecting or indicating the presence of the user 104. For example, a sensor 110 can be used to indicate whether the user 104 is on his/her telephone in his/her office or at least whether the user's 104 telephone is being used regardless of whether the user 104 is actually on the telephone or whether some other individual is using the telephone in the user's 104 office. In a second example, a sensor 110 can be a device that detects if an identification (“ID”) badge containing a radio-frequency ID (“RFID”) tag is within a detectable distance of the sensor 110. If such a sensor 110 is positioned in a conference room, for example, the sensor 110 can provide an indication of whether or not a user's 104 ID badge is in the room. In particular embodiments, similar devices can be placed, for example, in the office of various users or in places where users may meet spontaneously, such as a cafeteria or a break room.

A sensor 110 can be a software application that monitors one or more resources. For example, a sensor 110 may monitor other software applications that the user 104 may execute. In this manner, if the user 104 logs in to his/her computer, a sensor 110 may be programmed to indicate to the calendaring system 100 that the user 104 has logged in. Similarly, a sensor 110 may be used to indicate to the calendaring system 100 when a user has logged in to other software applications, such as an instant messaging (“IM”) system, or has changed a status in the software application. For example, if a sensor 110 is monitoring a user's 104 IM status, the sensor can provide the calendaring system 100 with the status that the user 104 has entered into the IM system, such as “on the phone”, “away,” or “be right back.”

The sensor module 112 operates as an interface between the sensors 110 and the control module 114. The sensor module 112 receives sensor-generated information and passes the information on to the control module 114. In particular embodiments, the sensor module 112 may operate on the information before passing the information on to the control module 114. For example, the control module 114 may be programmed to filter out non-requested or unneeded information from the information received by the sensor module 112 from the sensors 110 before passing the filtered information to the control module 114. In particular embodiments, the sensor module 112 may be programmed to put the information received from the sensors 110 into a particular format before passing the information on to the control module 114. In particular embodiments, the sensor module 112 may be programmed to customize or program the sensors 110. For example, a user 104 may wish to monitor another user's calendar for changes or a user 106 in management or security of an organization may wish to program the sensor module 112 to collect all sensor-generated information related to a particular user or group of users. In particular embodiments, the sensor module 112 may be a stand alone module while, in other embodiments, the sensor module may be an integral function of the control module 114.

Upon receiving sensor-generated information related to the user 104, the control module 114 may integrate the received sensor-generated information with scheduled-activity information related to the user 104. In particular embodiments, the control module 114 may integrate the two types of information by amending scheduled-activity information related to the user 104. For example, the user 104 may have previously entered a scheduled meeting that the user was to attend and that was scheduled to end at particular time. In particular embodiments, a sensor 110 may detect, at the time of the scheduled meeting, that the user's 104 ID badge, containing an RFID transmitting a unique ID number of the user 104, is located in or near a conference room in which the meeting was scheduled. If the sensor 110 detects that the ID badge remains in the conference room after the time for which the meeting was originally scheduled to end, the control module 114 may receive sensor-generated information indicating this detection and may integrate the sensor-generated information into the schedule-activity information (i.e., the originally scheduled meeting) by extending the ending time of the meeting in the user's 104 calendar. In this manner, other users that have access to the user's calendar can immediately see that the user 104 is not actually available, but instead, is still in the scheduled meeting.

In particular embodiments, the control module 114 may integrate the two types of information by creating a scheduled-activity related to the user 104. For example, the user 104 may have a period of time on his/her calendar that indicates that the user 104 is available or free. It should be noted that this period of time can be viewed as scheduled-activity information for which the user 104 has chosen not to provide a description of what specific activity the user 104 is scheduled to be engaged in. That is, it can be viewed as scheduled-activity information indicating the user is scheduled to be working on some unspecified task without a specified location. Sensor-generated information generally provides evidence of the user's 104 presence. The process of integrating scheduled-activity information with sensor-generated information may be viewed as enhancing the scheduled-activity information. Accordingly, embodiments disclosed herein may be referred to as presence-enhanced calendaring.

In particular embodiments, the calendaring system 100 may tag the sensor-generated information to differentiate the sensor-generated information from other information in the calendaring system 100, such as the scheduled-activity information. Tagging allows the calendaring system 100 to distinguish between different kinds of information. Thus, a calendaring system may, for example, allow the user 104 to choose between displaying the user's 104 scheduled-activity information while reflecting the tagged sensor-generated information and displaying the user's 104 scheduled-activity without reflecting the tagged sensor-generated information.

In particular embodiments, the calendaring system 100 may prompt the user 104 for input related to received sensor-generated information. For example, the calendaring system 100 may have received sensor-generated information indicating that the user 104 has entered their office and heuristically wish to modify the user's 104 scheduled-activity information to indicate that the user 104 is in their office instead of at lunch or a meeting, for example. The calendaring system 100 may prompt the user 104 before modifying the scheduled-activity information, allowing the user 104 the opportunity to modify the received sensor-generated information. For example, the user 104 may respond to the calendaring system's 100 prompt for input by entering information to indicate that the user 104 is “out to lunch.” In this manner, if a user 104 returns to their office from a meeting, the user 104 may wish to have their calendar reflect that they are out to lunch so that the user 104 can work through lunch in their office undisturbed by other users that may use the calendaring system 100 to inquire as to whether the user 104 is available.

In particular embodiments, the calendaring system 100 can be adapted to restrict which kinds of sensor-generated information may be modified by a user. Additionally, the calendaring system 100 may be adapted to allow the user 104 to modify the sensor-generated information for purposes of displaying the user's 104 calendar. For example, in the situation described above where the user 104 enters information to have the calendaring system 104 reflect to other users that the user 104 is “out to lunch,” the calendaring system 100 may keep a copy of the original sensor-generated information that indicates the user 104 is in his/her office. In this manner, the calendaring system 100 may indicate to some user's (e.g., peers of the user 104) that the user 104 is “out to lunch” while indicating to other users (e.g., management or security) that the user 104 is actually in their office.

The calendaring system 100 may receive sensor-generated information that either confirms or conflicts with received scheduled-activity information or other sensor-generated information. For example, the user 104 may have previously entered a meeting that the user is scheduled to attend in a particular conference room at a particular time. If, at the time of the scheduled meeting, the calendaring system receives sensor-generated information that a sensor has detected the user's 104 ID badge is in or close to the particular room, then the sensor-generated information will generally be viewed as confirming the scheduled-activity information. However, if the calendaring system 100 receives sensor-generated information indicating that, at the time of the scheduled meeting, the user's 104 ID badge is detected as being located in the user's 104 office instead of be located in or near the scheduled meeting room then the sensor-generated information will generally be viewed as conflicting with the scheduled-activity information.

In particular embodiments, the control module 114 may apply heuristics to received sensor-generated information before or during the integration of the received sensor-generated information with scheduled-activity information. For example, the calendaring system 100 may have received sensor-generated information that the user's 104 ID badge was in a conference room during a scheduled meeting in the room and is now in the user's office. The calendaring system 100 may also receive sensor-generated information indicating that somebody has now logged into the user's 104 computer using the user's 104 username and password. The calendaring system 100 may use heuristics to determine that these pieces of information are confirming and that the user's 104 scheduled activity may be modified to reflect that the scheduled meeting has indeed ended.

However, in another scenario, the calendaring system 100 may receive information that the user's 104 ID badge remains in a room past the time a scheduled meeting in the room was scheduled to end. At the same time, the calendaring system 100 may also receive information that somebody has now logged into the user's 104 computer in the user's 104 office, using the user's 104 username and password. The calendaring system 100 may use heuristics to determine that these pieces of information are conflicting and that the user 104 (and perhaps security) should be notified of the conflict.

The calendaring system 100 manages received scheduled-activity information, received sensor-generated information, and integrated information. Managing information will generally include storing the information enabling the calendaring system 100 to operate on the information at a later time. The information will typically be stored in the calendar module, although particular embodiments may also store information elsewhere, such as in a storage facility 260 that stores a plurality of files 262-1, 262-3, 262-N (generally 262) containing calendar event data comprising a history of events recorded by the calendar module 102. The calendaring system 100 may operate on the information by modifying the information. The information may be modified, for example, in response to input from the user or in response to receiving sensor-generated information. Managing information will generally include providing information to at least one user of the calendaring system 100. In particular embodiments, different portions of managed information may be provided to different users in accordance with user profiles maintained by the calendar system 100. For example, the user 104 may have a profile that prevents another user 106 from viewing some or all of the user 104's calendar data. That is, the user 106 may be able to view most of the managed information related to the user 104, but may be blocked from viewing some sensitive calendar data that user 104 does not want to share with user 106. Similarly, the user 104 may have a profile that allows the calendaring system 100 to block the user 106 from viewing all of the managed information related to the user 104 while at the same time allowing a different user (e.g., a user in management or security), having a different profile, to view all the managed information related to the user 104.

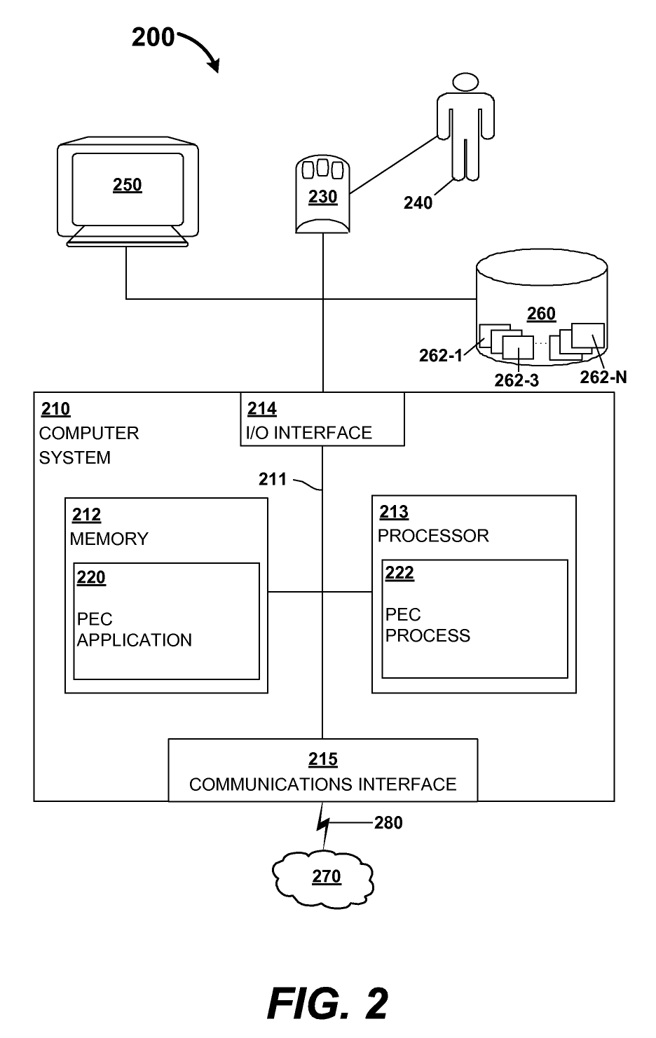

FIG. 2 is a block diagram of a computer environment 200 illustrating an example architecture of a respective computer system 210 useful for executing presence-enhanced calendaring (“PEC”) applications (i.e., methods, procedures, etc.) useful in implementing a calendaring system according to embodiments disclosed herein. Computer system 210 can be a computerized device such as a personal computer, workstation, portable computing device, console, network terminal, processing device, etc. As shown, computer system 210 of the present example includes an interconnect 211, such as a data bus or other circuitry, that couples a memory system 212, a processor 213, I/O interface 214, and a communications interface 215. An input device 230 (e.g., one or more user/developer-controlled devices such as a keyboard, mouse, touchpad, trackball, etc.) couples to the processor 213 through the I/O interface 214 and enables a user 240 to provide input commands and generally interact with a graphical user interface that the PEC application 220 and the PEC process 222 provide on a display 250. I/O interface 214 potentially provides connectivity to peripheral devices such as the input device 230, display screen 250, storage device 260, etc. The computer environment 200 includes a storage device 260 for storing calendar data comprising a history of calendar events.

Communications interface 215 enables computer system 210 to communicate with network 270 over the communication link 280 to retrieve and transmit information from remotely located sources if necessary. For example, the computer system 210 may be communicatively connected via the communication link 280 to a computer system on the network 270 that is executing other PEC applications.

As shown, memory system 212 can be any type of computer-readable medium and in this example is encoded with PEC application 220 that supports functionality as herein described. PEC application 220 can be embodied as computer software code such as data and/or logic instructions (e.g., code stored in the memory or on another computer-readable medium such as a disk) that supports processing functionality according to different embodiments described herein. During operation of the computer system 210, processor 213 accesses the memory system 212 via the interconnect 211 in order to launch, run, execute, interpret, or otherwise perform the logic instructions of the PEC application 220. Execution of the PEC application 220 produces processing functionality in a PEC process 222. In other words, the PEC process 222 represents one or more portions of the PEC application 220 performing within or upon the processor 213 in the computer system 210. Those skilled in the art will understand that the computer system 210 can include other processes and/or software and hardware components, such as an operating system that controls allocation and use of hardware resources.

It should be noted that, in addition to the PEC process 222 that carries out method operations as discussed herein, other embodiments herein include the PEC application 220 itself (i.e., the un-executed or non-performing logic instructions and/or data). The PEC application 220 may be stored on a computer-readable medium such as a floppy disk, hard disk, or in an optical medium. According to other embodiments, the PEC application 220 can also be stored in a memory type system such as in firmware, read-only memory (ROM), or, as in this example, as executable code within the memory system 212 (e.g., within Random Access Memory or RAM). Thus, it should be understood that embodiments disclosed herein include logic encoded in one or more tangible media for execution and, when executed, operable to perform methods and processes disclosed herein. Such logic may be embodied strictly as computer software, as computer software and hardware, or as hardware alone.

Communications interface 215 enables computer system 210 to communicate with network 270 over the communication link 280 to retrieve and transmit information from remotely located sources if necessary. For example, computer system 210, executing PEC application 220, may be communicatively connected, via the communication link 280, to a computer system executing other PEC applications or to sensors. Together, the executing PEC applications may implement a single calendaring system in accordance with embodiments disclosed herein.

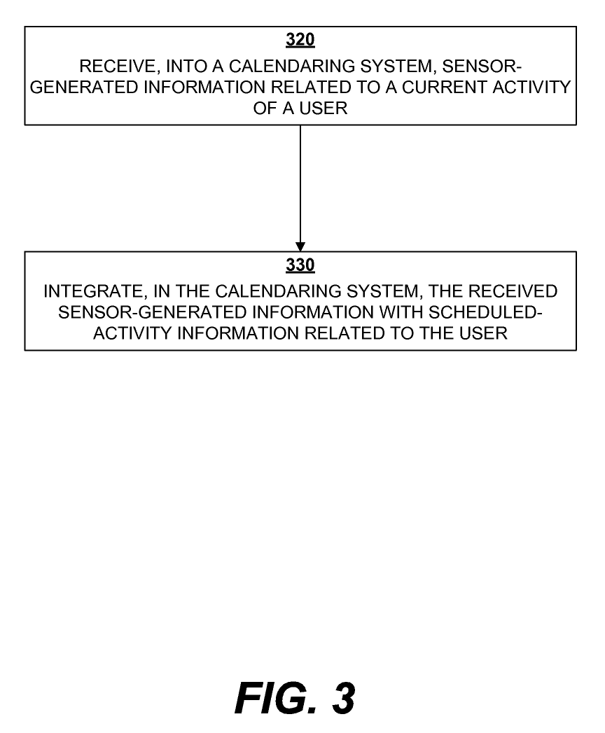

Functionality supported by computer system 210 and, more particularly, functionality associated with PEC application 220 and PEC process 222 is herein discussed in relation to FIGS. 3-6. For purposes of the following discussion, computer system 210 generally is capable of performing procedures in FIGS. 3-6. However, other systems can be configured to provide similar functionality.

FIG. 3 illustrates procedures performable by logic in accordance with embodiments disclosed herein. In step 320, a calendaring system receives sensor-generated information related to a current activity of a user. In step 330, the calendaring system integrates the received sensor-generated information with scheduled-activity information related to the user.

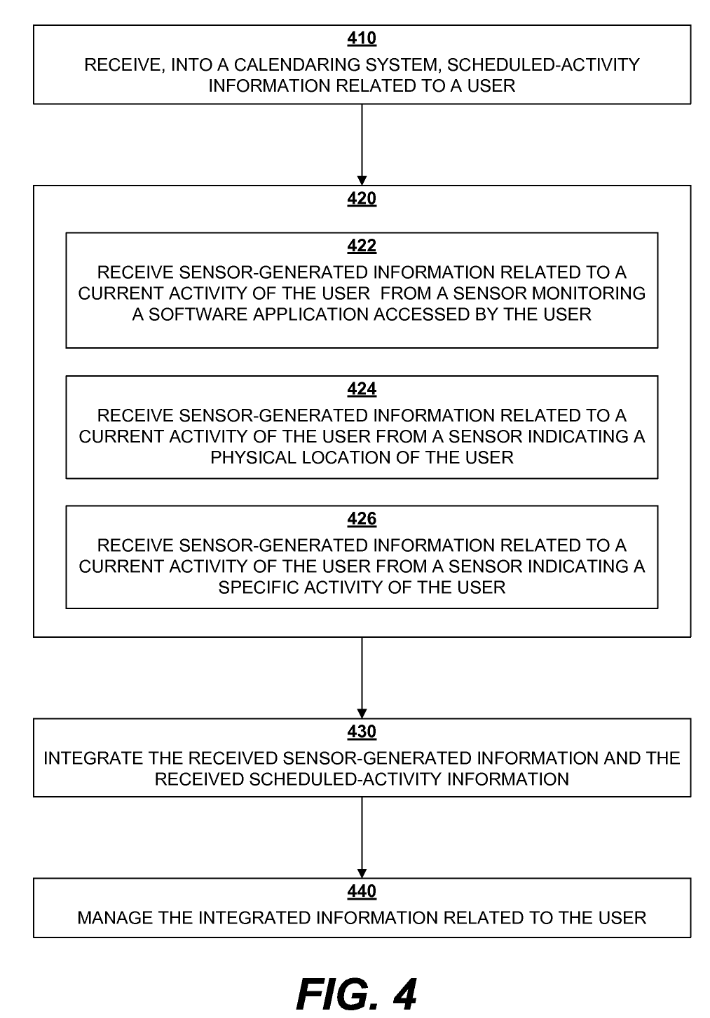

FIG. 4 illustrates additional procedures performable by a calendaring system in accordance with embodiments disclosed herein. In step 410, the calendaring system receives scheduled-activity information related to a user.

In step 420, the calendaring system receives sensor-generated information related to a current activity of the user. Step 420 may be the same as step 320. In step 420, the calendaring system may perform one or more of steps 422, 424, and 426.

In step 422, the calendaring system receives sensor-generated information related to a current activity of the user from a sensor monitoring a software application accessed by the user. In particular embodiments, the sensor may provide information indicating that the user is accessing the software application. For example, the sensor may provide information indication that a username and a password assigned to the user has been accessed. In particular embodiments, the sensor may provide more detailed information about how the software application is being utilized by the user.

In step 424, the calendaring system receives sensor-generated information related to a current activity of the user from a sensor indicating a physical location of the user. For example, the sensor may be a sensor capable of detecting an RFID in the user's ID badge as described herein. Other types of sensors capable of indicating a physical location of the user may include motion detectors and cameras, for example.

In step 426, the calendaring system receives sensor-generated information related to a current activity of the user from a sensor indicating a specific activity of the user. For example, a sensor may provide information indicating that the user is accessing a telephone or other device.

In step 430, the calendaring system integrates the received sensor-generated information and the received scheduled-activity information. Step 430 may be the same as step 330. In step 440, the calendaring system manages the integrated information related to the user.

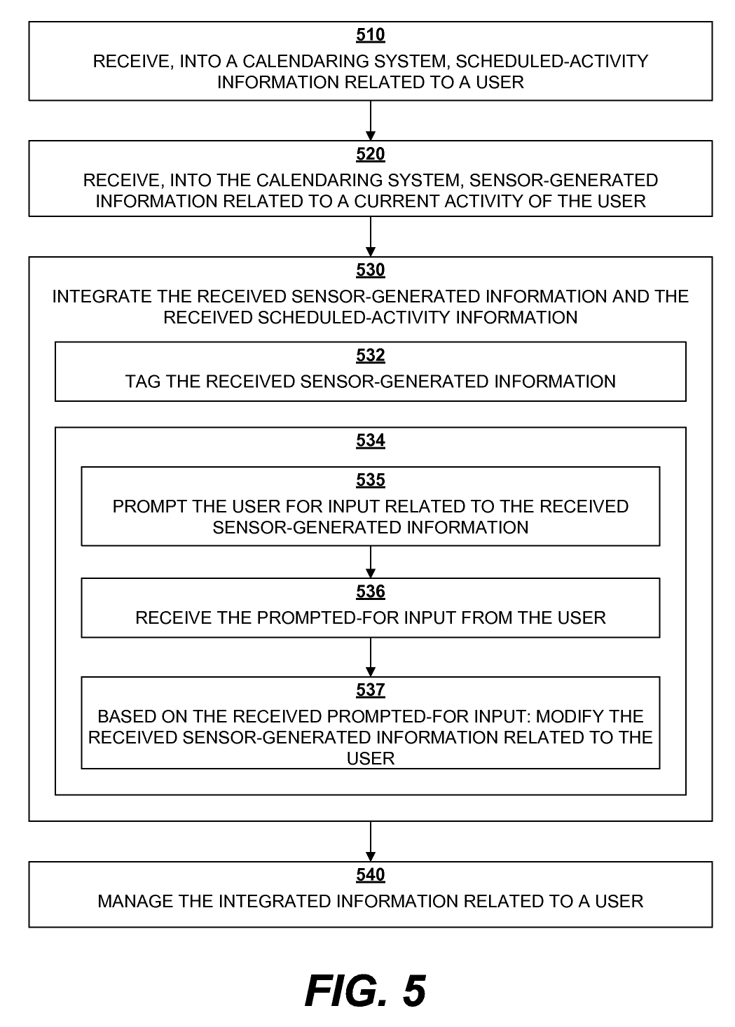

FIG. 5 illustrates additional procedures performable by a calendaring system in accordance with embodiments disclosed herein. In step 510, the calendaring system receives scheduled-activity information related to a user. Step 510 may be the same as step 410. In step 520, the calendaring system receives sensor-generated information related to a current activity of the user. Step 520 may be the same as step 420 or 320.

In step 530, the calendaring system integrates the received sensor-generated information and the received scheduled-activity information. In step 530, the calendaring system may perform one or more of steps 532 and 534.

In step 532, the calendaring system tags the received sensor-generated information. Tagging the sensor-generated information allows the calendaring system to treat the sensor-generated information differently than other information, if necessary. For example, a user may request scheduled-activity information previously integrated with tagged sensor-generated information to be displayed separately from the tagged sensor-generated information.

Step 534 comprises steps 535, 536, and 537. In step 535, the calendaring system prompts the user for input related to the received sensor-generated information. For example, the calendaring system may prompt the user to indicate whether the user would like to integrate the received sensor-generated information into the user's scheduled-activity information. Additionally, the calendaring system may prompt the user to allow the user an opportunity to modify the received sensor-generated information before integrating the sensor-generated information and the scheduled-activity information.

In step 536, the calendaring system receives the prompted-for input from the user. For example, the user may provide input requesting the received sensor-generated information be modified prior to integrating it or requesting that the received sensor-generated information be modified by deleting the information. In step 537, the calendaring system based on the received prompted-for input, modifies the received sensor-generated information related to the user.

In step 540, the calendaring system manages the integrated information related to the user. Step 540 may be the same as step 440.

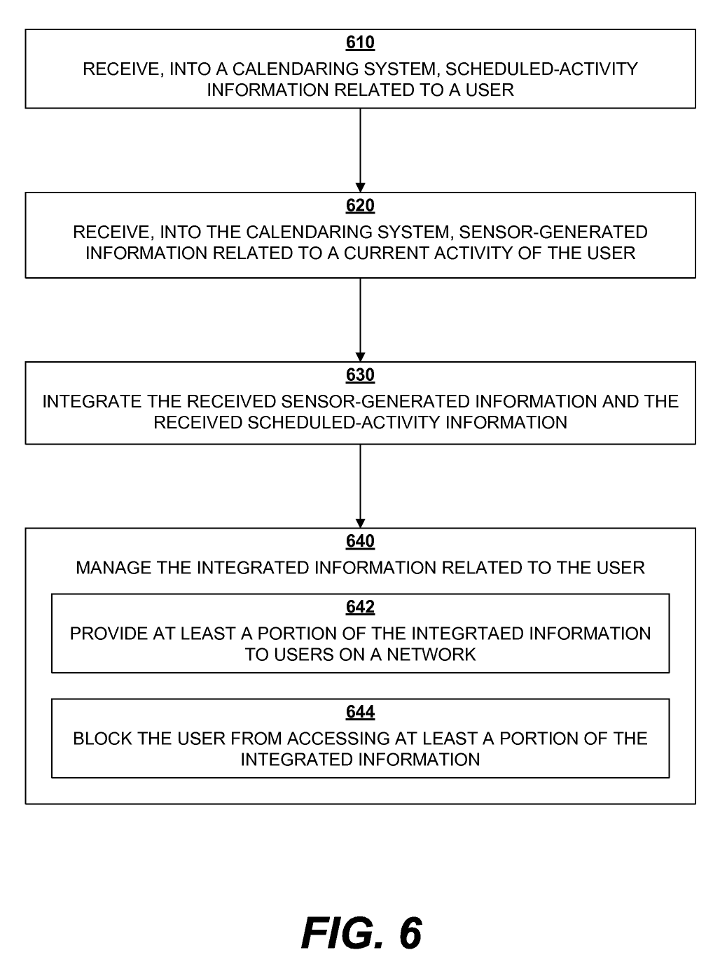

FIG. 6 illustrates additional procedures performable by a calendaring system in accordance with embodiments disclosed herein. In step 610, the calendaring system receives scheduled-activity information related to a user. Step 610 may be the same as step 510, step 410, or step 310. In step 620, the calendaring system receives sensor-generated information related to a current activity of the user. Step 620 may be the same as step 520, step 420, or step 320. In step 630, the calendaring system integrates the received sensor-generated information and the received scheduled-activity information. Step 630, may be the same as step 530, step 430, or step 330.

In step 640, the calendaring system manages the integrated information related to the user. In step 640, the calendaring system may perform one or more of the steps 642 and 644. In step 642, the calendaring system provides at least a portion of the integrated information to users on a network. The calendaring system can provide the integrated information in accordance with user profiles. In step 644, the calendaring system blocks the user from accessing at least a portion of the integrated information. The calendaring system can block the user in accordance with user profiles.

In accordance with embodiments described herein, presence-enhanced calendaring is provided. While inventive matter has been shown and described herein with reference to specific embodiments thereof, it should be understood by those skilled in the art that variations, alterations, changes in form and detail, and equivalents may be made or conceived of without departing from the spirit and scope of the inventive matter. The foregoing description of the inventive matter is not intended to be limiting. Rather, the scope of the inventive matter should be assessed as that of the appended claims and by equivalents thereof.

What is claimed is:

1. Logic encoded in one or more tangible media for execution and, when executed, operable to:
receive, into a calendaring system, sensor-generated information related to a current activity of a user of the calendaring system; and
integrate, in the calendaring system, the received sensor-generated information with scheduled-activity information related to the user.

2. The logic of claim 1, operable to:
receive sensor-generated information related to a current activity of the user from a sensor monitoring a software application accessed by the user.

3. The logic of claim 1, operable to:
receive sensor-generated information related to a current activity of the user from a sensor indicating a physical location of the user.

4. The logic of claim 1, operable to:
receive sensor-generated information related to a current activity of the user from a sensor indicating a specific activity of the user.

5. The logic of claim 1, operable to:
provide access to the integrated information to users on a network.

6. The logic of claim 1, operable to:
prompt the user for input related to the received sensor-generated information;
receive the prompted-for input from the user; and
based on the received prompted-for input:
modify the received sensor-generated information related to the user.

7. A method comprising:
receiving, into a calendaring system, sensor-generated information related to a current activity of a user of the calendaring system; and
integrating, in the calendaring system, the received sensor-generated information with scheduled-activity information related to the user.

8. The method of claim 8, comprising:
receiving the sensor-generated information related to a current activity of the user from a sensor monitoring a software application accessed by the user.

9. The method of claim 8, comprising:
receiving the sensor-generated information related to a current activity of the user from a sensor indicating a physical location of the user.

10. The method of claim 8, comprising:
receiving the sensor-generated information related to a current activity of the user from a sensor indicating a specific activity of the user.

11. The method of claim 8, comprising:
providing access to the integrated information to users on a network.

12. The method of claim 8, comprising:
prompting the user for input related to the received sensor-generated information;
receiving the prompted-for input from the user; and
based on the received prompted-for input:
modifying the received sensor-generated information related to the user.

13. A calendaring system comprising:
a user interface adapted to receive scheduled-activity information related to a user;
a sensor adapted to generate information related to a current activity of the user;
a sensor module adapted to receive sensor-generated information related to the user;
a control module adapted to integrate received sensor-generated information related to the user with received scheduled-activity information related to the user; and
a calendar module adapted to maintain the integrated information.

14. The system of claim 15, wherein the sensor is adapted to monitor a software application for access by the user.

15. The system of claim 15, wherein the sensor is adapted to indicate a physical location of the user.

16. The system of claim 15, wherein the sensor is adapted to indicate a specific activity of the user.

17. The system of claim 15, comprising:
a plurality of sensors, each sensor adapted to generate information related to a current activity of the user.

18. The system of claim 15, wherein the calendaring system is adapted to provide access to the integrated information to users on a network.
